(19) United States
(12) Patent Application Publication
(10) Pub. No.: US 2017/0355571 A1
(43) Pub. Date: Dec. 14, 2017

(54) ELECTRICAL ENERGY GENERATION WITHIN AN ELEVATOR INSTALLATION

(71) Applicant: Inventio AG, Hergiswil (CH)

(72) Inventor: Henrique Ferreira, Sao Paulo (BR)

(21) Appl. No.: 15/537,448

(22) PCT Filed: Dec. 14, 2015
(86) PCT No.: PCT/EP2015/079584

§ 371 Date: Jun. 19, 2017

(30) Foreign Application Priority Data
Dec. 18, 2014 (EP) 14198949.1

(51) Int. Cl. B66B 15/04; D07B 1/14; D07B 1/22; B66B 7/06

(52) U.S. Cl. CPC B66B 15/04; B66B 7/062; D07B 1/147; D07B 1/22; D07B 2501/2007

(57) ABSTRACT

An elevator installation and method to passively and reliably generate electrical energy while the elevator installation is in operation utilizes piezoelectric layers. The elevator installation includes an elevator car, a tension member for supporting and moving the elevator car, and a pulley engaging with the tension member wherein the pulley has a piezoelectric layer positioned such that any force imparted to the pulley during engagement with the tension member compresses the piezoelectric layer. As the tension member is driven to move the elevator car up and down along an elevator hoistway it also engages with the rotating pulley. Force imparted to the pulley during this engagement with the tension member compresses the piezoelectric layer which consequently generates electrical energy.

### FIELD

The present invention relates to elevator installations and particularly to the passive generation of electrical energy while such an elevator installation is in operation.

### BACKGROUND

The use of piezoelectric elements has been proposed previously within the field of elevators to generate control signals, which are fed to an elevator controller enabling the controller to regulate operation of the elevator. For example, JP-A-2002068618 and U.S. Pat. No. 6,715,587 both describe the use of piezoelectric elements mounted either between or to one of an elevator car and its associated frame. The piezoelectric elements in these examples are provided as pressure sensors, which generate signals to an elevator controller enabling the controller to determine changes in the load within an elevator car. JP-A-2011213479 similarly describes the use of a pressure sensor which, on this occasion, is inserted at the bottom of a groove of a traction sheave to diagnose wear of the groove.

EP-A1-1780159 and EP-A2-0636569 describe elevator operating panels, which are generally provided on each landing to enable prospective passengers waiting on the landing to call an elevator. Similar panels may also be mounted within the elevator car to allow boarded passengers to enter their required destination floor. In both the arrangements, piezoelectric elements are used within the operating panels as buttons such that upon exertion of sufficient pressure by a passenger's finger, the elements generate the required signal to the elevator controller and can also illuminate an LED to indicate acceptance of the passenger's call.

Accordingly, piezoelectric elements have been used as pressure sensors within elevators to generate control signals either for determining the changes in the load within an elevator car or for diagnosing wear of a sheave groove or acting as call signals for transmission to the elevator controller.

However, since load changes within the elevator car occur rather intermittently, groove wear is gradual, and buttons on the operating panel have a small cross-sectional area and can be operated with relatively little pressure, none of these applications of piezoelectric elements within elevators is sufficient to generate a reliable supply of energy.

### SUMMARY

The present invention has been developed to overcome the above-identified problems related to the described prior art.

An objective of the present invention is to provide an elevator and method to passively and reliably generate electrical energy while an elevator installation is in operation.

The elevator installation comprises an elevator car, a tension member for supporting and moving the elevator car and a pulley engaging with the tension member, wherein the pulley comprises a piezoelectric layer positioned such that any force imparted to the pulley during engagement with the tension member compresses the piezoelectric layer and further includes a power storage unit having an input electrically connected to an anode and a cathode of the piezoelectric layer. Thereby electrical energy generated by the piezoelectric layer can be harvested in the power storage unit.

As the tension member is driven to move the elevator car up and down along an elevator hoistway, it also engages with the rotating pulley. Force imparted to the pulley during this engagement with the tension member compresses the piezoelectric layer, which consequently generates electrical energy. Given, firstly, the relatively high rotational speed of elevator pulleys and, secondly, the substantial compressive force differentials exerted on the pulley during each rotation, a significant and reliable supply of electrical energy can be generated by the piezoelectric layer when the elevator is in operation.

Preferably, the piezoelectric layer is applied to an outer circumferential surface of the pulley and engages with the tension member. Accordingly, the tension member directly compresses the piezoelectric layer as it travels over the pulley.

The pulley can further comprise a shaft, which is rotatably supported by a bearing mounted in a support bracket. Consequently, the pulley and shaft rotate in unison and forces are transmitted from the tension member, through the pulley and its shaft and to the support bracket via the bearing.

In this arrangement, the piezoelectric layer can be provided on an outer circumferential surface of the shaft that is rotatably supported by the bearing. This can be used in addition or as an alternative to the previously described arrangement where the piezoelectric layer is applied to an outer circumferential surface of the pulley and engages with the tension member.

In another alternative arrangement, the pulley may have an inner circumferential surface and is supported by a bearing on a non-rotating axle. Here again the piezoelectric layer can be applied to the inner circumferential surface to generate electrical energy during rotation.

Although the power storage unit can be mounted on and thereby is rotated in unison with the pulley, it is envisaged that it would be more beneficial to mount the power storage unit remotely from the pulley. In such a case the anode and the cathode of the piezoelectric layer can be electrically connected to a first and a second conductive ring, respectively. The rings are mounted to either the pulley shaft or to a side face the pulley. Brushes can be used to slidably engage with the rotating conductive rings. Preferably the brushes are spring biased into engagement with the rings. The brushes can then be electrically connected to the input of the power storage unit. Thereby, electrical energy generated by the rotating pulley can be transmitted to the stationary power storage unit.

Energy generated can be transferred into an electrical energy bank within the power storage unit and can be stored for subsequent use. The electrical energy bank may comprise batteries, capacitors, fuel cells or any other form of DC electrical energy storage.

Depending on the respective voltage ratings of the piezoelectric layer and the electrical energy bank, it may be necessary to insert a DC to DC converter between the input of the power storage unit and the electrical energy bank.

Preferably, energy harvested within the power storage unit can be supplied to external electrical loads via one or more outputs. If the external load has the same voltage rating as the energy bank, it can be supplied from a DC output connected directly to the energy bank. Alternatively, the voltage from the energy bank can be bucked, boosted or otherwise transformed by a DC to DC converter to supply external electrical loads having different voltage ratings via a further DC output. Furthermore, a DC to AC inverter can be used to invert the DC power from the energy bank into AC power, which can be supplied to external electrical loads via an AC output.

The invention further provides a method for providing electrical energy within an elevator installation, wherein a tension member supports and moves an elevator car. The method comprises the steps of incorporating a piezoelectric layer in a pulley, compressing the piezoelectric layer when the tension member engages with the pulley and electrically connecting the piezoelectric layer to a power storage unit.

Subsequently, the electrical energy harvested can be supplied from the power storage unit to an electrical load.

### DESCRIPTION OF THE DRAWINGS

The invention will be described herein with reference to the following drawings in which:

FIG. 1 is an exemplary schematic showing a conventional arrangement of components within an elevator installation according to the present invention;

FIG. 2 is an axial, plan view of a traction sheave arrangement according to an exemplary embodiment suitable for use in the elevator installation of FIG. 1;

FIG. 3 is a cross-sectional view of an exemplary embodiment of the support bracket of FIG. 2;

FIG. 4 is a cross-sectional view of an exemplary embodiment of the traction sheave of FIG. 2;

FIG. 5 is a perspective view of an exemplary embodiment of the traction sheave of FIGS. 2 and 4;

FIG. 6 is a schematic of an exemplary embodiment of a power storage unit in which energy generated by the piezoelectric layer of FIGS. 3 and 4 is harvested;

FIG. 7 is a cross-sectional view of an exemplary embodiment of one of the underslung, car mounted pulleys of FIG. 1; and

FIG. 8 is an axial, cross-section view showing the engagement the tension member with a pulley according to an exemplary embodiment of the present invention.

### DETAILED DESCRIPTION

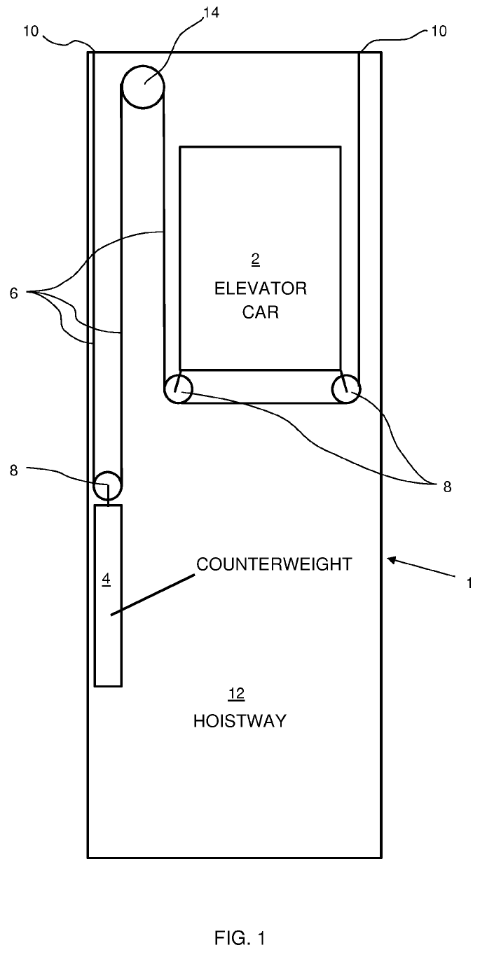

FIG. 1 illustrates an exemplary embodiment of a conventional arrangement of components within an elevator installation 1. An elevator car 2 and a counterweight 4 are supported on a traction member 6 by means of deflection pulleys 8. In this example, the tension member 6 has a 2:1 roping ratio whereby it extends from one termination 10 in an elevator hoistway 12 under a deflection pulley 8 mounted to the top of the counterweight 4, back up the hoistway 12 for engagement with a traction sheave 14 driven by a motor, down to a pair of underslung pulleys 8 mounted underneath the car 2 and finally back up to a further termination point 10 in the hoistway 12. Naturally, the person skilled in the art will easily recognize that alternative roping arrangements are equally applicable and that the traction sheave 14 and its associated motor can be mounted within the shaft 12 to provide what is conventionally known as a machine-room-less (MRL) installation, as shown, or alternatively can be provided in a separate and dedicated machine room.

In operation, as the traction sheave 14 is rotated by the motor, it engages with the traction member 6 to vertically move the car 2 and counterweight 4 in opposing directions along guiderails (not shown) within the hoistway 12.

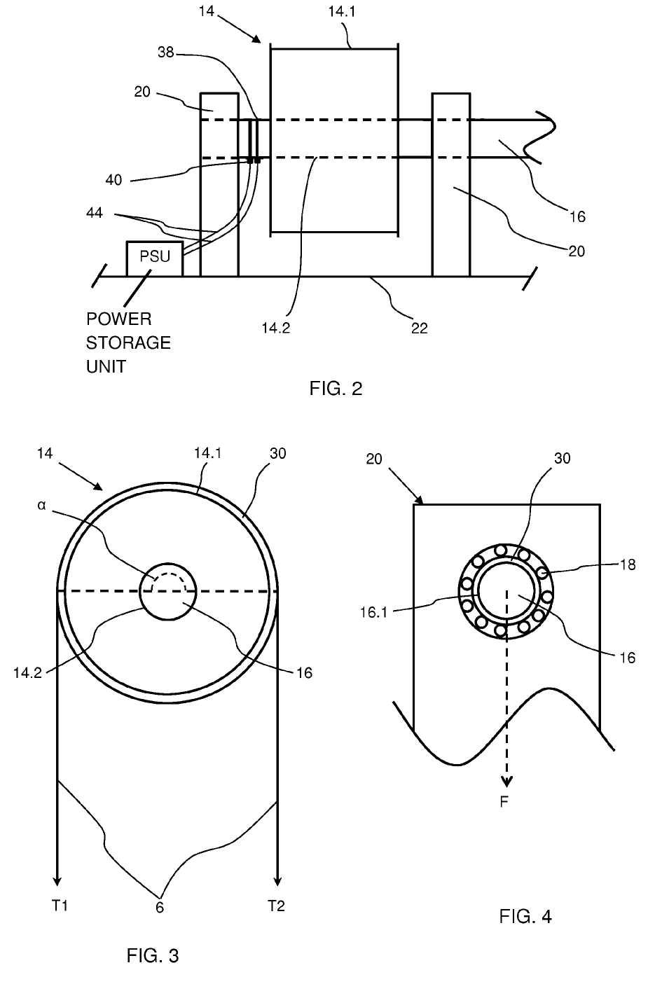

FIG. 2 is an axial, plan view of an exemplary embodiment of a traction sheave 14 arrangement suitable for use in the elevator installation 1 of FIG. 1. The traction sheave 14 has an inner circumferential surface 14.2, which is splined to or otherwise fixed to a shaft 16 for concurrent rotation. The traction sheave shaft 14 can be integral with, or directly or indirectly coupled to the drive shaft of the motor. The shaft 16 is rotatably supported by bearings 18 mounted in support brackets 20 arranged at opposing sides of the traction sheave 14. The brackets 20 are mounted on a structural beam 22 either in the hoistway 12 or in a machine room.

FIG. 3 is a cross-sectional view of an exemplary embodiment of the traction sheave of FIG. 2. The outer circumferential surface 14.1 of the traction sheave 14 that engages with the tension member 6 is coated with a piezoelectric layer 30. In operation, the tensions T1 and T2 exerted through the sections of the tension member 6 leading to the counterweight 4 and to the car 2, respectively, will be transmitted through the piezoelectric layer 30 as distributed contact force over the wrap angle α through which the tension member 6 engages the traction sheave 14. In the present example the wrap angle is 180°, forming the upper semi-circular segment of the traction sheave 14. The traction sheave itself will naturally provide a counteracting and distributed normal force over the same wrap angle α. The interaction of the opposing contact and normal forces exerted on the piezoelectric layer 30 will generate electrical energy.

Accordingly, in operation as the piezoelectric layer 30 rotates, it will have minimal compression while located in the lower semi-circular travel segment of the traction sheave 14. However, as the tension member enters into engagement with the traction sheave 14, the compression exerted on the piezoelectric layer 30 progressively increases to a maximum compression in the upper travel region of the traction sheave 14. Thereafter, the compression exerted on the piezoelectric layer 30 progressively decreases to the minimal compression once again when the tension member 6 disengages with the traction sheave 14.

The rated speed of a traction sheave 14 will vary widely depending on application. Typical factors that are taken into consideration include sheave diameter, wrap angle α, rated load, travel height, roping ratio and tension member type. Consequently, the traction sheave 14 may have a rated speed ranging from the tens to the hundreds of revolutions per minute (rpm).

Given, firstly, the relatively high rotational speed of the traction sheave 14 and, secondly, the substantial compressive force differentials exerted on the piezoelectric layer 30 during each rotation of the traction sheave 14, a significant and reliable supply of electrical energy can be generated by the piezoelectric layer 30 when the elevator 1 is in operation.

FIG. 4 is a cross-sectional view of an exemplary embodiment of the support bracket 20 of FIG. 2 and depicts an additional or alternative embodiment for generating electrical energy within an elevator 1. In this example, a piezoelectric layer 30 is provided on the outer circumferential surface of the shaft 16 that is rotatably supported by bearing 18 mounted in the support brackets 20. The vertical tensions T1 and T2 imparted on the traction sheave 14 by the tension member 6 are ultimately transmitted through the shaft 16 to the portions thereof which are supported on the brackets 20 and manifests as a downward contact force F. Each of the brackets 20 will exert a counteracting normal force through the bearing 18. The interaction of the opposing contact and normal forces exerted on the piezoelectric layer 30 will generate electrical energy.

During operation of the elevator, the piezoelectric layer 30 will have minimal compression while located in the upper semi-circular segment of rotation. However, as the piezoelectric layer 30 travels through the lower semi-circular segment of rotation, its compression will increase progressively to a maximum compression and progressively decrease to the minimal compression once again.

As with the traction sheave 14 of FIG. 3, the piezoelectric layer 30 mounted on the shaft 16 will experience a relatively high rotational speed and substantial compressive force differentials during rotation. Thereby, a significant and reliable supply of electrical energy can be generated by the when the elevator 1 is in operation.

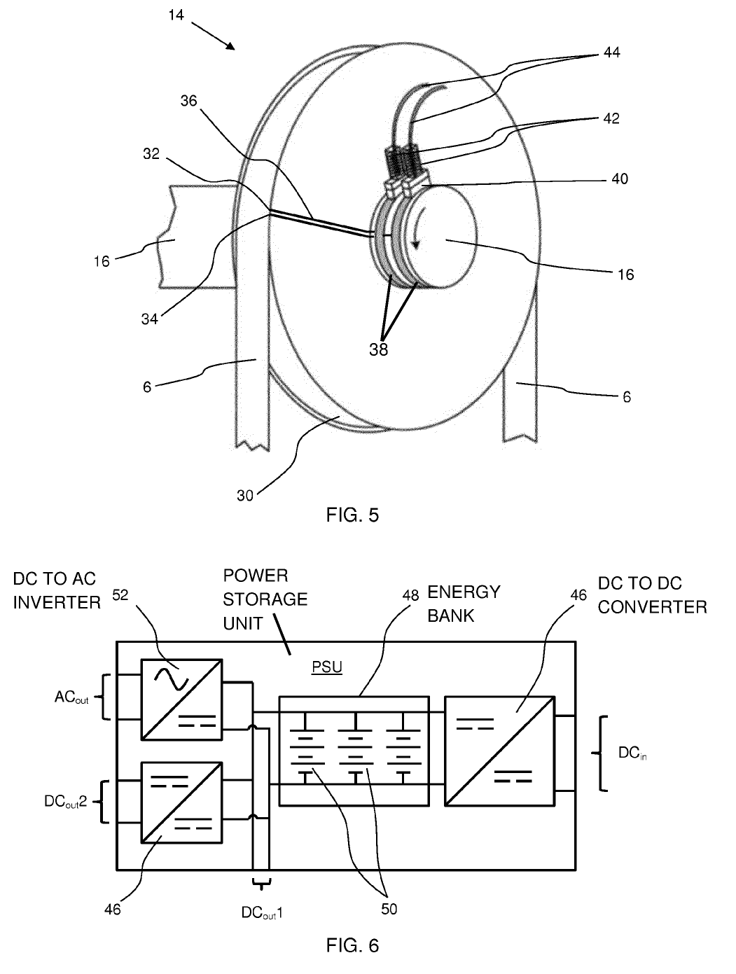

FIG. 5 is a perspective view of an exemplary embodiment of the traction sheave of FIGS. 2 and 3 and provides an example of how the electrical energy generated by the piezoelectric layer 30 can be harvested. Anode(s) 32 and cathode(s) 34 of the piezoelectric layer 30 are connected by insulated wire 36 to a first and a second conductive ring 38, respectively. The rings 38 are mounted over but insulated from the shaft 16. Carbon brushes 40, mounted to a stationary frame (not shown), are biased by compression springs 42 into engagement with the exposed surfaces of the conductive rings 38. Power is drawn from the conductive rings 38, through the carbon brushes 40, through power cables 44 connected to the brushes 40 and supplied onto a power storage unit PSU, as shown in FIG. 2. It will be appreciated that the same technique can be used to transmit the energy generated in the arrangement of FIG. 4.

The DC voltages supplied along cables 44 are used as an input DCᵢₙ to the power storage unit PSU, as shown in FIG. 6. Within the power storage unit PSU, the electrical energy from the input DCᵢₙ can be feed through a DC to DC converter 46 and is ultimately stored in an energy bank 48, which in this instance comprises a plurality of rechargeable batteries 50. Naturally, other forms of DC electrical energy storage such as capacitors, fuel cells etc. are equally feasible.

Power harvested in the DC energy bank 48 can be fed directly to a first DC output DCₒᵤₜ1 and supplied further to electrical loads operating with the same voltage rating as the energy bank 48. Alternatively, the voltage from the energy bank 48 can be bucked, boosted or otherwise transformed by a further DC to DC converter 46 to supply external electrical loads having different voltage ratings via a second DC output DCₒᵤₜ2. Furthermore, a DC to AC inverter 52 can be used to invert the DC power from the energy bank 48 into AC power, which is supplied to external electrical loads via an AC output ACₒᵤₜ.

Although the above description relates to the generation of electrical energy from a traction sheave 14 and its associated shaft 16, it will be appreciated that the same principles can be applied to any pulley used within the elevator installation 1 that engages with the tension member 6.

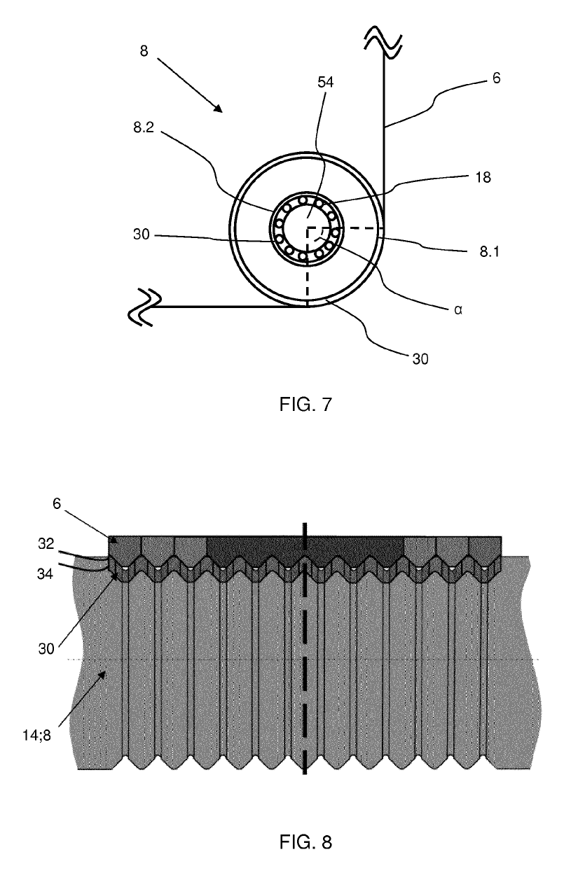

For example, FIG. 7 is a cross-sectional view of an exemplary embodiment of one of the underslung, car mounted pulleys 8 of FIG. 1. As with the traction sheave 14 from the preceding embodiments, an outer circumferential surface 8.1 of the deflection pulley 8 that engages with the tension member 6 is coated with a piezoelectric layer 30. However, contrary to the earlier embodiments, the pulley 8 is not fixed to a shaft for concurrent rotation but instead is rotatably mounted via bearing 18 on a non-rotating axle 54 which in turn is mounted to the elevator car 2. A further piezoelectric layer 30 is applied to the inner circumferential surface 8.2 of the deflection pulley 8.

The distributed contact force imparted to the deflection pulley 8 as it engages with the tension member 6 over the wrap angle α and the counteracting normal force exerted by the non-rotating axle 54 through the bearing 18 will substantially compress both piezoelectric layers 30 and thereby generate electrical energy.

Although the wrap angle α at 90° is considerably smaller than in the previous examples and the force exerted by the tension member 6 on the pulley 8 is also smaller, the deflection pulley 8 generally has a much smaller diameter and therefore its rotational speed is considerably greater than that of the traction sheave 14. Accordingly, a significant and reliable supply of electrical energy can still be generated by the piezoelectric layer 30 when the elevator 1 is in operation.

Preferably, using the same principle as described with reference to FIG. 5, the power generated by the piezoelectric layer 30 is transmitted to conductive rings, this time provided on a side face of the pulley 8, through carbon brushes and onto a power storage unit PSU mounted to the elevator car 2. Accordingly the power harvested within the power storage unit PSU can be supplied to electrical loads within the car 2 such as lighting, ventilation, operating panels etc.

FIG. 8 is an axial, cross-section view showing the engagement the tension member 6 with a pulley according to an exemplary embodiment of the present invention. The form of the pulley can be applied to either a traction sheave 14 in accordance with FIGS. 1-5 or to a deflection pulley 8 in accordance with FIGS. 1 and 7. The tension member 6 is in the form a ribbed belt and the outer circumferential surface of the pulley 14 or 8 has corresponding grooves. The piezoelectric layer 30 is provided between the grooves of the pulley 14 or 8 and the tension member 6. The anode 32 and cathode 34 of the piezoelectric layer 30 are extended to one side of the layer 30 and can be subsequently connected electrically as outlined above with reference to FIG. 5.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator installation comprising:
an elevator car;
a tension member supporting and moving the elevator car;
a pulley engaging with the tension member wherein the pulley has a piezoelectric layer positioned such that any force imparted to the pulley during engagement with the tension member compresses the piezoelectric layer; and
a power storage unit having an input electrically connected to an anode and a cathode of the piezoelectric layer for receiving electrical energy generated by the piezoelectric layer.

15. The elevator installation according to claim 14 wherein the piezoelectric layer is applied to an outer circumferential surface of the pulley and engages with the tension member.

16. The elevator installation according to claim 14 wherein the pulley includes a shaft and the shaft is rotatably supported by a bearing mounted in a support bracket, and wherein the piezoelectric layer is provided on an outer circumferential surface of the shaft that is rotatably supported by the bearing.

17. The elevator installation according to claim 14 wherein the pulley has an inner circumferential surface and is supported by bearing on a non-rotating axle, and wherein the piezoelectric layer is applied to the inner circumferential surface.

18. The elevator installation according to claim 14 wherein the anode and the cathode of the piezoelectric layer are electrically connected to a first conductive ring and a second conductive ring, respectively.

19. The elevator installation according to claim 18 including brushes engaging with the conductive rings.

20. The elevator installation according to claim 19 wherein the brushes are electrically connected to the input of the power storage unit.

21. The elevator installation according claim 14 wherein the power storage unit includes an electrical energy bank for storing the electrical energy.

22. The elevator installation according to claim 21 wherein the power storage unit includes a DC to DC converter interconnecting the input and the electrical energy bank.

23. The elevator installation according to claim 21 wherein the power storage unit includes a DC output either directly connected to the electrical energy bank or connected through a DC to DC converter to the electrical energy bank.

24. The elevator installation according to claim 21 wherein the power storage unit includes a DC to AC rectifier interconnecting the electrical energy bank to an AC output.

25. A method for providing electrical energy within an elevator installation, wherein a tension member supports and moves an elevator car, comprising the steps of:
incorporating a piezoelectric layer in a pulley;
compressing the piezoelectric layer by engaging the pulley with the tension member; and
electrically connecting the piezoelectric layer to a power storage unit for receiving electrical energy generated by the piezoelectric layer.

26. The method according to claim 25 including a step of supplying electrical energy from the power storage unit to an electrical load.
